(19) United States
(12) Patent Application Publication
(10) Pub. No.: US 2011/0199438 A1
(43) Pub. Date: Aug. 18, 2011

(54) LIQUID EJECTING HEAD AND LIQUID EJECTING APPARATUS

(75) Inventor: Yutaka KOBAYASHI, Ikeda-machi (JP)

(73) Assignee: SEIKO EPSON CORPORATION, Tokyo (JP)

(21) Appl. No.: 13/006,322

(22) Filed: Jan. 13, 2011

(30) Foreign Application Priority Data
Feb. 16, 2010 (JP) 2010-31000

(51) Int. Cl. B41J 2/175

(52) U.S. Cl. 347/85

(57) ABSTRACT

Even if a bubble, which has a circular cross-section during its flowing whose diameter is longer than the short-axis length and shorter than the long-axis length of an oval shape that corresponds to the shape of an opening in a supply opening, reaches the supply opening, a gap occurs between the supply opening and the bubble, and thus the supply opening is not completely covered.

The entire disclosure of Japanese Patent Application No. 2010-31000, filed Feb. 16, 2010 is expressly incorporated herein by reference.

### BACKGROUND

1. Technical Field

The present invention relates to liquid ejecting heads and liquid ejecting apparatuses.

2. Related Art

In a typical example of a liquid ejecting head, piezoelectric elements are provided in multiple pressure chambers with which multiple nozzle openings respectively communicate, and voltages are applied to the piezoelectric elements, which causes the piezoelectric elements to constrict or expand; this in turn causes the pressure chambers to depressurize, thus supplying ink, or pressurizes the pressure chambers, which causes ink droplets to be ejected from the nozzle openings.

As disclosed in JP-A-2004-306381, ink is supplied to each pressure chamber via a supply opening from an ink holding chamber, which is a manifold. The cross-sectional shape of the supply opening is a circle.

Here, when a liquid is caused to be ejected from a nozzle opening by pressurizing the interior of the pressure chamber, it is necessary to reduce the backflow of liquid from the pressure chamber into the manifold in order to obtain favorable ejection properties; there is thus an optimal size for, and an upper limit on, the surface area of the supply opening.

For a variety of reasons, bubbles of various sizes form in the liquid within the manifold. Such bubbles within the liquid cover the supply opening on the manifold side of a supply path that spans from the manifold to the pressure chamber.

When the supply opening is covered by a bubble, the supply of the liquid is inhibited, and when the pressure chamber is depressurized and to supply liquid, an excessive amount of liquid is pulled from the nozzle opening; as a result, even if the pressure chamber is pressurized, the liquid will not be ejected from the nozzle opening.

If an excessive amount of liquid is once pulled from the nozzle opening, the liquid will not be ejected from the nozzle opening even if the bubbles move away from the supply opening and the supply opening is unobstructed.

Furthermore, the bubbles will also move to other supply openings due to the flow of the liquid within the manifold, and will cover those supply openings; this leads to an increase in the number of nozzle openings that experience ejection problems, which in turn causes ejection problems in the liquid ejecting head and the liquid ejecting apparatus that cannot be ignored.

### SUMMARY

A liquid ejecting head according to an aspect of the invention includes: multiple pressure chambers that communicate with corresponding nozzle openings that eject a liquid; a pressure generation unit that generates the pressure in the pressure chambers; a manifold that is a common liquid chamber communicating with the multiple pressure chambers; supply paths that fluidly communicate with the multiple pressure chambers to the manifold; and supply openings, formed on the manifold side of corresponding supply paths, having openings that have a shape in which an inscribing circle is present.

A liquid ejecting apparatus according to another aspect of the invention includes the aforementioned liquid ejecting head.

### BRIEF DESCRIPTION OF THE DRAWINGS

The invention will be described with reference to the accompanying drawings, wherein like numbers reference like elements.

FIG. 1 is a general perspective view illustrating an ink jet recording apparatus according to a first embodiment of the invention.

FIG. 2 is an exploded perspective view illustrating an outline of an ink jet recording head according to the invention.

FIG. 3 is a partial plan view of an ink jet recording head according to the invention.

FIG. 4 is a general cross-sectional view of an ink jet recording head according to the invention as viewed along the IV-IV line in FIG. 3.

FIG. 5 is a partial enlarged plan view illustrating a supply opening according to the invention as viewed from a manifold.

FIG. 6 is a partial enlarged plan view illustrating a bubble reaching a supply opening according to the invention.

FIGS. 7A, 7B, and 7C are partial enlarged plan views illustrating a supply opening according to a variation on the invention as viewed from a manifold.

FIG. 8A is a partial enlarged plan view illustrating a supply opening according to a second embodiment of the invention as viewed from a communication opening formation plate, whereas FIG. 8B is a general cross-sectional view as viewed along the VIIIB-VIIIB line in FIG. 8A.

FIG. 9 is a partial enlarged plan view illustrating a bubble reaching a supply opening according to the invention.

### DESCRIPTION OF EXEMPLARY EMBODIMENTS

Hereinafter, embodiments of the invention will be described in detail based on the drawings.

### First Embodiment

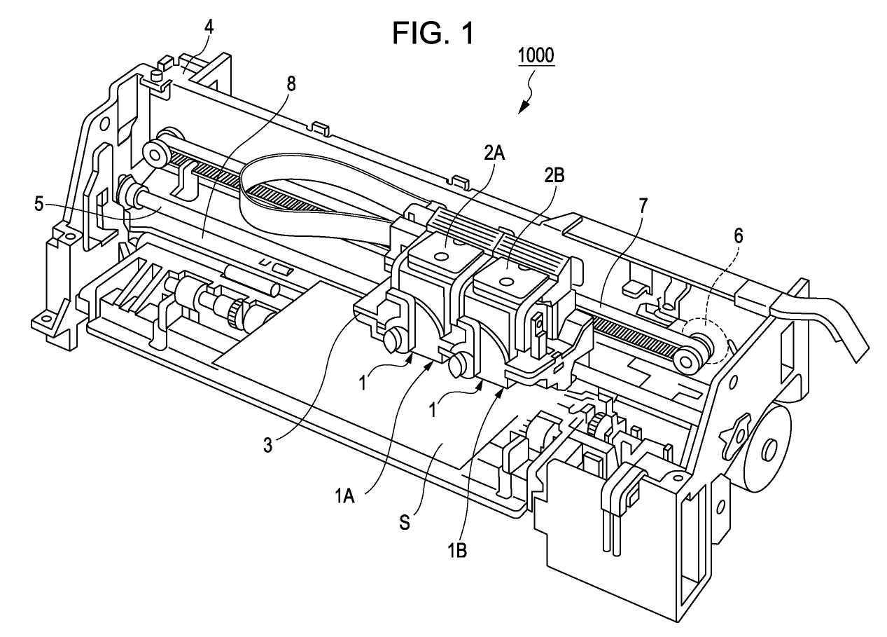

FIG. 1 is a general perspective view illustrating an ink jet recording apparatus 1000 serving as an example of a liquid ejecting apparatus according to an embodiment of the invention. The ink jet recording apparatus 1000 is an apparatus that carries out recording by ejecting ink, as a liquid, onto a recording sheet S, serving as a recording medium.

In FIG. 1, the ink jet recording apparatus 1000 includes recording head units 1A and 1B that have ink jet recording heads 1, which serve as liquid ejecting heads. Cartridges 2A and 2B, of which ink supply units are configured, are provided in the recording head units 1A and 1B, respectively, in a removable state.

Here, the ink jet recording heads 1 are provided on the sides of the recording head units 1A and 1B, respectively, that face the recording sheet S, and thus are not shown in FIG. 1.

A carriage 3 in which the recording head units 1A and 1B are mounted is disposed so as to be mobile in the axial direction of a carriage shaft 5 provided within a main apparatus body 4. The recording head units 1A and 1B eject, for example, black ink compositions and color ink compositions, respectively.

Transmitting driving force generated by a driving motor 6 to the carriage 3 via multiple gears (not shown) and a timing belt 7 moves the carriage 3, in which the recording head units 1A and 1B are installed, along the carriage shaft 5.

Meanwhile, a platen 8 is provided in the main apparatus body 4 along the carriage 3. This platen 8 is capable of rotating as a result of driving force supplied by a paper feed motor (not shown), and the recording sheet S, which is a recording medium such as paper that is supplied by a paper supply roller or the like, is wound upon the platen 8 and transported.

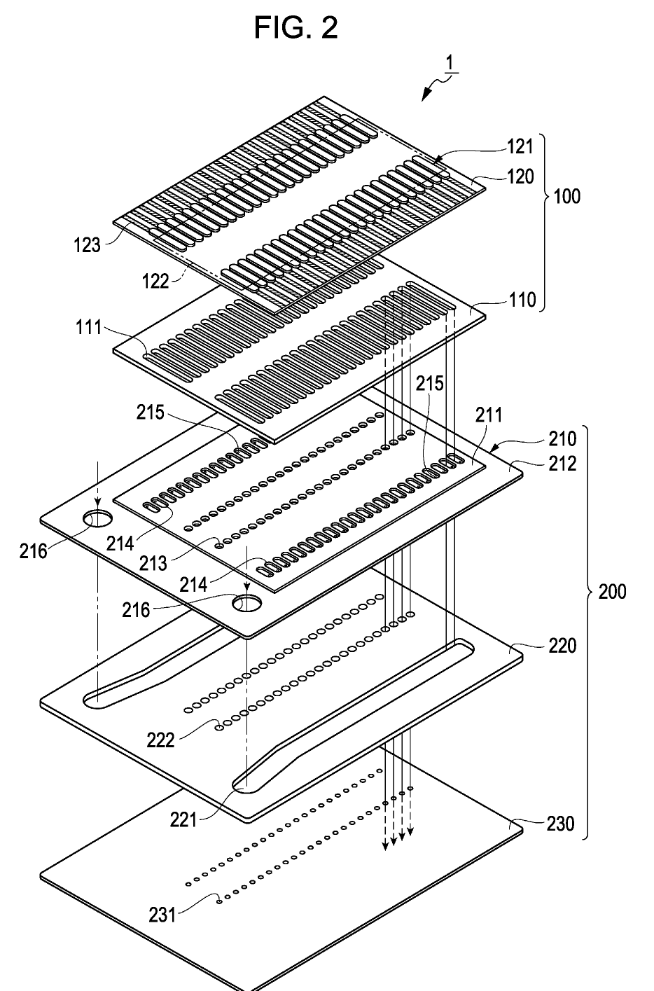

Hereinafter, the ink jet recording head 1 will be described in detail with reference to FIGS. 2, 3, and 4.

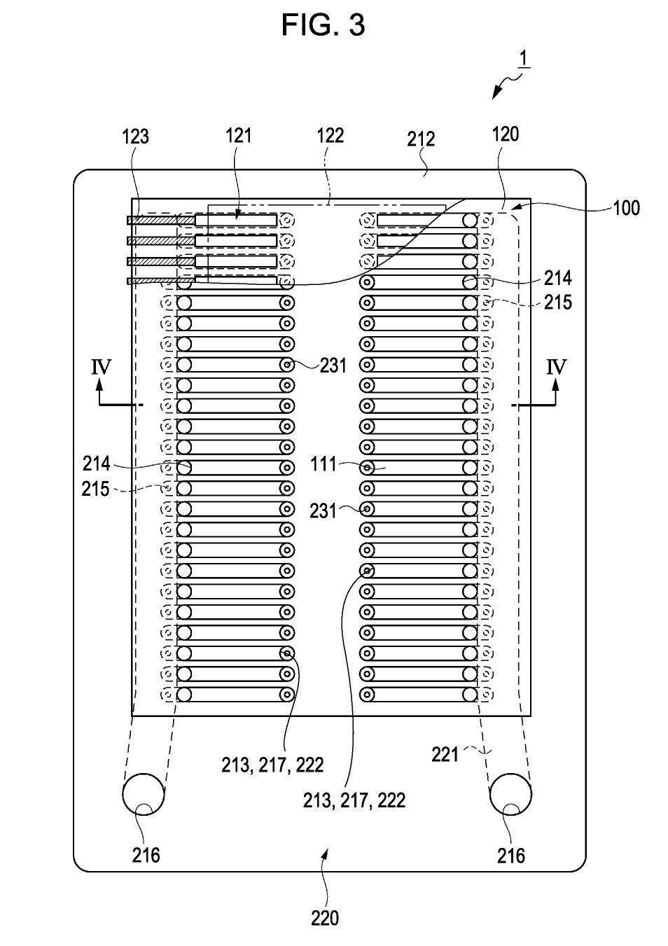

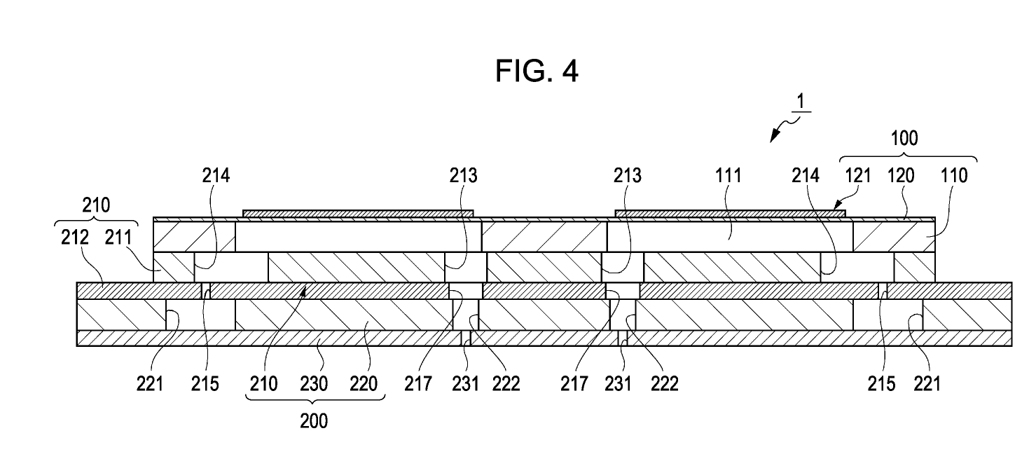

FIG. 2 is an exploded perspective view illustrating an outline of the ink jet recording head 1, FIG. 3 is a partial plan view of the ink jet recording head 1, and FIG. 4 is a general cross-sectional view illustrating the ink jet recording head 1 as viewed along the IV-IV line in FIG. 3.

In FIGS. 2, 3, and 4, the ink jet recording head 1 includes an actuator unit 100 and a flow channel unit 200.

In FIGS. 2 and 4, the actuator unit 100 includes a pressure chamber formation plate 110 and a vibration plate 120. The vibration plate 120 is formed on one side of the pressure chamber formation plate 110. Meanwhile, in FIGS. 2, 3, and 4, multiple spaces that form pressure chambers 111 are provided in rows in the pressure chamber formation plate 110. Accordingly, the vibration plate 120 configures part of the pressure chambers 111.

In FIGS. 2 and 3, piezoelectric vibrators 121, which are piezoelectric elements that serve as plate-shaped pressure generation units corresponding to respective pressure chambers 111, are provided on the side of the vibration plate 120 that is opposite to the side that configures part of the pressure chambers 111. The piezoelectric vibrators 121 include a common lower electrode 122 that is formed in the vibration plate 120 and individual upper electrodes 123 that correspond to the respective piezoelectric vibrators 121.

In FIGS. 2 and 4, the flow channel unit 200 includes a supply path formation plate 210, a manifold formation plate 220, and a nozzle plate 230.

The flow channel unit 200 is configured by superimposing the supply path formation plate 210 and the nozzle plate 230 on the manifold formation plate 220 provided therebetween.

The supply path formation plate 210 of the flow channel unit 200 is affixed to the surface of the pressure chamber formation plate 110 of the actuator unit 100 that is on the opposite side as the side on which the vibration plate 120 is formed. Accordingly, along with the vibration plate 120, the supply path formation plate 210 configures part of the pressure chambers 111.

Part of manifolds 221 are formed in the manifold formation plate 220, whereas nozzle openings 231 are formed in the nozzle plate 230. The manifolds 221 are configured by superimposing the supply path formation plate 210 and the nozzle plate 230 on the manifold formation plate 220 provided therebetween.

The ink jet recording head 1 loads ink from the cartridges 2A and 2B, and the interior thereof is filled with ink from the manifolds 221 to the nozzle openings 231. After this, a driving voltage is applied between the lower electrode 122 and the upper electrodes 123 in locations corresponding to the pressure chambers 111 in accordance with driving signals from a driving IC (not shown), thus causing the piezoelectric vibrators 121 and the vibration plate 120 to bend and deform; this increases the pressure within the pressure chambers 111, which in turn causes ink droplets to be ejected from the nozzle openings 231.

Detailed descriptions of the supply path formation plate 210 will be given hereinafter.

In FIGS. 2 and 4, the supply path formation plate 210 includes a communication opening formation plate 211 and a supply opening formation plate 212.

In FIGS. 2, 3, and 4, communication openings 213 through which the pressure chambers 111 communicate with the nozzle openings 231 and communication openings 214, serving as supply paths for ink, through which the manifolds 221 and the pressure chambers 111 communicate are formed in the communication opening formation plate 211.

Each pressure chamber 111 is formed in an oblong shape, with one end thereof communicating with one of the manifolds 221 via one of the communication openings 214 and the other end thereof communicating with one of the nozzle openings 231 via one of the communication openings 213.

The communication openings 213 and 214 are provided in respective rows that follow the direction in which the pressure chambers 111 are provided. The row of the communication openings 213 is formed in a location that corresponds to the inner side of the pressure chambers 111, whereas the row of the communication openings 214 is formed in a location that corresponds to the outer side of the pressure chambers 111.

Supply openings 215 that supply ink from the manifolds 221 to the pressure chambers 111 are formed in the supply opening formation plate 212. The ink is supplied to the pressure chambers 111 through the communication openings 214 via the supply openings 215, which serve as supply paths for the ink from the manifolds 221.

Meanwhile, in FIGS. 2 and 3, two ink introduction openings 216, which introduce ink from the cartridges 2A and 2B into respective manifolds 221, are provided in the supply opening formation plate 212.

Furthermore, in FIG. 4, communication openings 217 that communicate between the communication openings 213 and the nozzle openings 231, respectively, are formed in the supply opening formation plate 212.

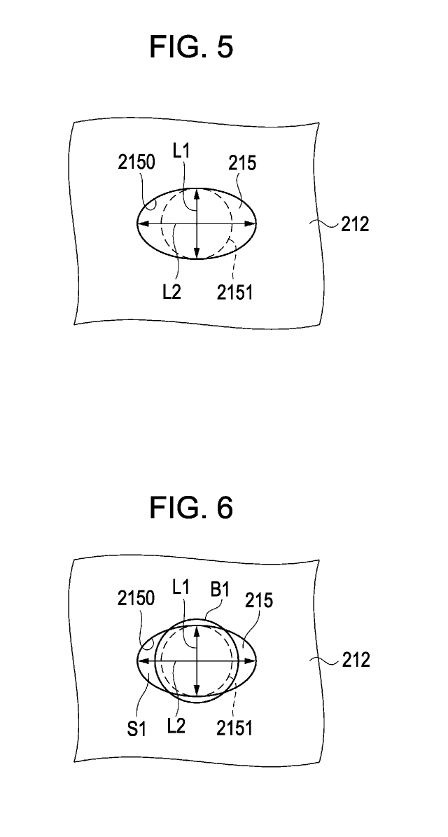

FIG. 5 is a partial enlarged plan view illustrating the supply opening formation plate 212, in which the supply opening 215 is formed, as viewed from the side of the manifolds 221.

An opening 2150 of the supply opening 215 has an oval shape, with the short-axis having a length of L1, and the long-axis having a length of L2. The oval shape has an inscribing circle 2151 that has a diameter L1.

In FIGS. 2, 3, and 4, two spaces that form the manifolds 221, which are common liquid chambers that distribute ink to the multiple pressure chambers 111, are formed in the manifold formation plate 220 so as to correspond to the two rows of pressure chambers 111. In addition, nozzle communication openings 222 that communicate with the respective nozzle openings 231 are provided in rows corresponding to the two rows of pressure chambers 111.

In FIGS. 2 and 3, both of the manifolds 221 extend in the row direction of the pressure chambers 111, and each manifold is provided in parallel relative to one row of pressure chambers 111 so as to be aligned with one end of each of the pressure chambers 111. Meanwhile, one end of each manifold 221 serves as an ink introduction portion, and this ink introduction portion communicates with a respective ink introduction opening 216.

Two rows of the nozzle openings 231 are provided in the nozzle plate 230 so as to correspond to respective rows of pressure chambers 111 in the actuator unit 100.

According to the embodiment as described thus far, the following effects can be achieved.

FIG. 6 is a partial enlarged plan view illustrating a bubble B1 reaching a supply opening 215. Here, the size of the bubble B1, which has been generated and mixed with the ink in the manifold 221, has a diameter of approximately 20 μm to 50 μm.

(1) Even if the bubble B1, which has a circular cross-section during its flowing and whose diameter is longer than the short-axis length L1 and shorter than the long-axis length L2 of the oval shape that corresponds to the shape of an opening 2150 of the supply opening 215, reaches the supply opening 215, a gap S1 occurs between the supply opening 215 and the bubble B1, and thus the supply opening 215 is not completely covered. Accordingly, ink can be supplied from the manifold 221 to the pressure chambers 111, thus making it possible to realize an ink jet recording head 1 that reduces problems with the ejection of ink from the nozzle openings 231.

Although the short-axis length L1 and the long-axis length L2 of the oval shape can be set in accordance with the size of the bubbles that are present, if the diameter of the bubble B1 is approximately 20 μm to 50 μm, setting the size of the short-axis length L1 to less than 20 μm and the size of the long-axis length L2 to more than 50 μm makes it difficult for the bubble B1 to pass through the supply opening 215, resulting in the supply opening 215 being covered.

(2) Setting the shape of the opening 2150 to be an oval shape that is close to being circular makes the machining thereof easy to carry out, and makes it possible to increase the size of the gap S1, which is the region that is outside in the long-axis direction of the area where the inscribing circle 2151 makes contact with the shape of the opening 2150 of the supply opening 215, which in turn makes it possible to realize an ink jet recording head 1 that reduces problems with the ejection of ink from the nozzle openings 231.

(3) This also makes it possible to obtain an ink jet recording apparatus 1000 that has the aforementioned effects.

### Variations

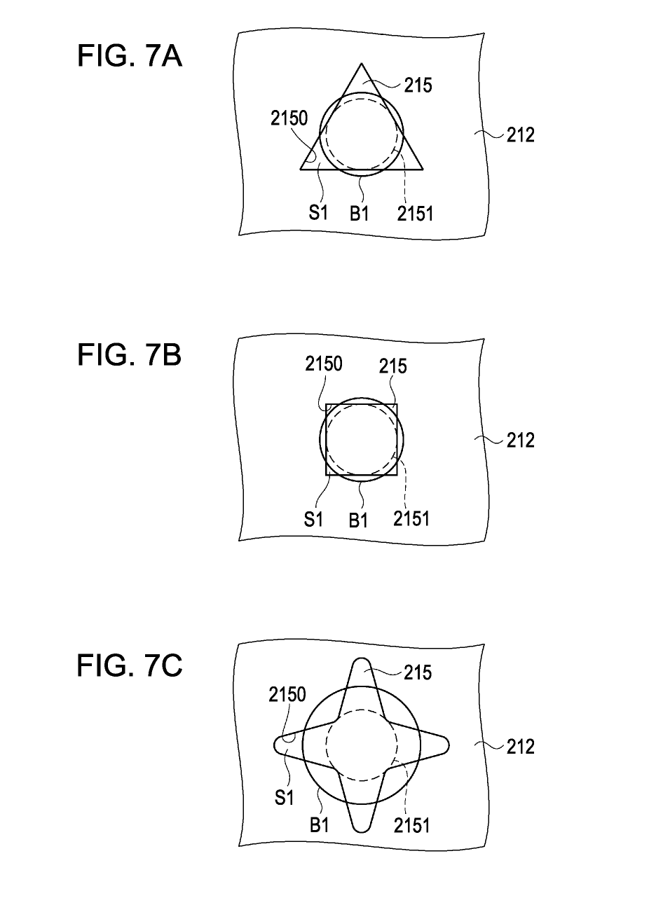

FIGS. 7A through 7C are partial enlarged plan views illustrating the supply opening formation plate 212 in which the supply openings 215 are formed, as viewed from the manifold 221, according to a variation on the first embodiment. Constituent elements that are the same as those in the first embodiment are given the same reference numerals.

FIG. 7A illustrates the case where the shape of the opening 2150 of the supply opening 215 is an equilateral triangle, FIG. 7B illustrates the case where the shape of the opening 2150 of the supply opening 215 is a square, and FIG. 7C illustrates the case where the shape of the opening 2150 of the supply opening 215 is a plus sign.

According to the variations as described thus far, the following effects can be achieved.

(4) In all of the variations, the supply openings 215 formed in the manifold side of the communication openings 214 and supply openings 215 through which the pressure chambers 111 communicate with the manifolds 221 have openings 2150 of a shape in which the inscribing circle 2151 is present. The bubble B1, which has a cross-section during its flowing that is smaller than the inscribing circle 2151, passes through the supply opening 215, and thus does not cover the supply opening 215. Meanwhile, even if the bubble B1, which has a cross-section during its flowing that is greater in size than the inscribing circle 2151 that is smaller than a circle that completely covers the gap S1, which is the region that is outside the area where the inscribing circle 2151 makes contact with the shape of the opening 2150 of the supply opening 215, stops in the opening 2150 of the supply opening 215, the ink will pass through the supply opening 215 through the gap S1, which is outside the area where the inscribing circle 2151 makes contact with the shape of the opening 2150 of the supply opening 215. Accordingly, the size of bubbles that will completely cover the supply opening 215 can be increased as compared to a circular supply opening that has approximately the same opening surface area, which makes it possible to realize an ink jet recording head 1 and an ink jet recording apparatus 1000 that reduce problems with the ejection of ink from the nozzle openings 231.

Although any shape may be used for the opening 2150 of the supply opening 215 as long as it is a shape that has the inscribing circle 2151, it is preferable for the shape to be a shape in which the gap S1 is present even if the size of the bubble B1 is changed. For example, if the extending portions of the plus sign shape illustrated in FIG. 7C are lengthened, a wide range of sizes for the bubble B1 may be acceptable.

### Second Embodiment

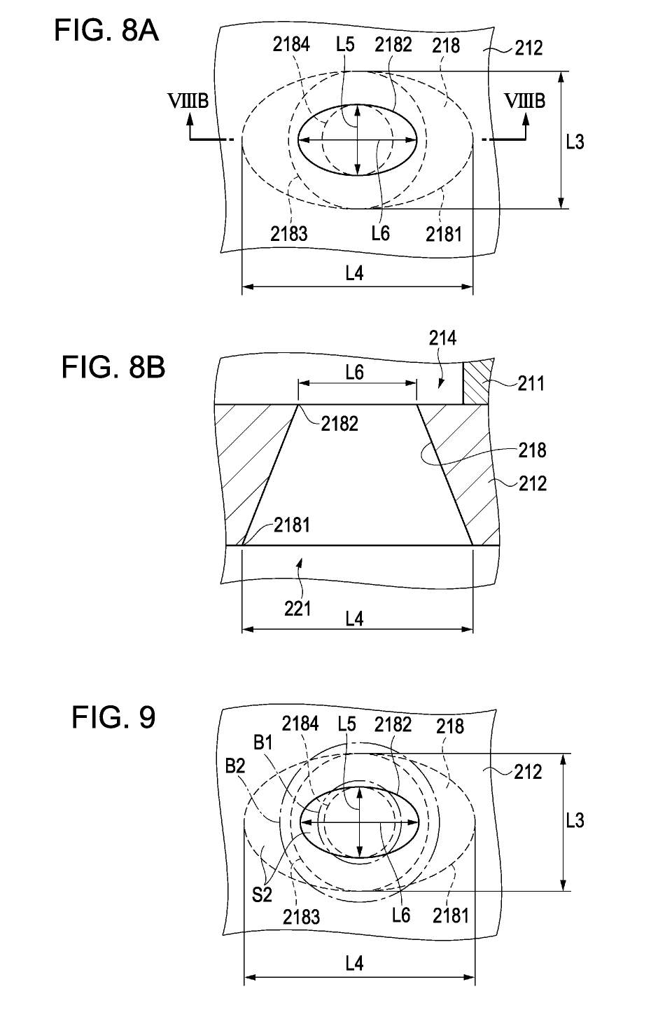

FIG. 8A is a partial enlarged plan view illustrating the supply opening formation plate 212 in which the supply openings 218 are formed, as viewed from the communication opening formation plate 211 in which the communication openings 214 are formed, according to an embodiment of the invention, and FIG. 8B is a general cross-sectional diagram viewed along the VIIIB-VIIIB line in FIG. 8A.

The shape of the openings in the supply openings 218 according to this embodiment is a tapered oval shape. A first opening 2181 on the side of the manifold 221 is an oval shape having a short-axis length L3 and a long-axis length L4, whereas a second opening 2182 on the side of the communication opening 214 is an oval shape having a short-axis length L5 and a long-axis length L6.

The first opening 2181 has a first inscribing circle 2183, whereas the second opening 2182 has a second inscribing circle 2184.

In this embodiment, the first opening 2181 and the second opening 2182 in the supply opening 218 configure a tapered oval shape; however, the shape of the first opening and the second opening is not limited to an oval as long as a first opening that opens into the manifold 221 and has a shape that has a first inscribing circle and a second opening that is provided more toward the pressure chambers than the first opening and that has a shape that has a second inscribing circle that is smaller than the first inscribing circle are provided. Furthermore, the supply opening 218 is not limited to a tapered shape, and may instead have, for example, a multi stepped shape.

According to the embodiment as described thus far, the following effects can be achieved.

FIG. 9 is a partial enlarged plan view illustrating a bubble B1 and a bubble B2 reaching a supply opening 218. The bubble B1 has a cross-section during its flowing that is a circle whose diameter is longer than the diameter L5 of the second inscribing circle 2184 but whose diameter is shorter than the long-axis length L6. The bubble B2 has a cross-section during its flowing that is a circle whose diameter is longer than the diameter L3 of the first inscribing circle 2183 but whose diameter is shorter than the long-axis length L4.

(5) In order to reduce the backflow of ink from the pressure chambers 111 into the manifolds 221 resulting from the opening surface area of the second opening 2182, the size of the first opening 2181 that opens into the manifolds 221 can be increased and the size of the bubble B2 that completely covers the supply opening 218 can also be increased while limiting the size of the supply opening 218 on the side of the pressure chambers 111. Accordingly, it is possible to realize an ink jet recording head 1 and an ink jet recording apparatus 1000 that reduce problems with the ejection of ink from the nozzle openings 231 while maintaining the ejection properties.

(6) Although the bubble B1, whose cross-section during its flowing is a circle whose diameter is shorter than the short-axis length L3 of the first opening 2181, passes through the first opening 2181, the long-axis length L6 of the second opening 2182 is longer than the short-axis length L3 of the first opening 2181, and thus even if the second opening 2182 is covered by the bubble B1, the size of a gap S2, which is the region that is outside in the long-axis direction of the second opening 2182, can be increased; thus ink is supplied from the manifolds 221 to the pressure chambers 111. Accordingly, it is possible to realize an ink jet recording head 1 and an ink jet recording apparatus 1000 that reduce problems with the ejection of ink from the nozzle openings 231.

The short-axis length L3 and the long-axis length L4, as well as the short-axis length L5 and the long-axis length L6, of the oval-shaped first opening 2181 and second opening 2182, respectively, can be set in accordance with the size of the bubbles that are present. For example, if the diameters of the bubbles B1 and B2 are approximately 20 μm to 50 μm, setting the short-axis length L3 of the first opening 2181 to less than 50 μm, the long-axis length L4 of the first opening 2181 to more than 50 μm, the short-axis length L5 of the second opening 2182 to less than 20 μm, and the long-axis length L6 of the second opening 2182 to more than 20 μm makes it difficult for the bubbles B1 and B2 to cover the supply opening 218.

(7) A bubble that has a cross-section during its flowing that is a circle whose diameter is in a range from the diameter of the first inscribing circle 2183 to the second inscribing circle 2184 is highly likely to stop in the supply opening 218, which makes it possible to reduce the likelihood of the bubble moving to another supply opening 218 and covering that supply opening 218. Accordingly, it is possible to realize an ink jet recording head 1 and an ink jet recording apparatus 1000 that have even slight ejection problems.

Although the invention has been described thus far according to embodiments, the invention is not intended to be limited to the basic configuration described above.

For example, although the ink jet recording head 1 according to the aforementioned embodiments changes the volume of the pressure chambers 111 using flexurally vibrating piezoelectric vibrators 121 as pressure generation units, the volume of the pressure chambers 111 may be changed using longitudinal vibrations.

Moreover, the pressure generation unit may be a device in which heating elements are disposed within the pressure chambers and liquid is ejected from the nozzle openings due to bubbles forming as a result of the heat from the heating elements, a so-called electrostatic actuator that generates static electricity between a vibration plate and an electrode, with the resulting static electricity force causing the vibration plate to distort and liquid to be ejected from the nozzle openings, or the like.

Although the ink jet recording head 1 has been described as an example of a liquid ejecting head, coloring material ejecting heads used in the manufacture of color filters for liquid-crystal displays and the like, electrode material ejecting heads used in the formation of electrodes for organic EL displays, FEDs (field emission displays), and so on, bioorganic matter ejecting heads used in the manufacture of biochips, and so on can be given as other examples of liquid ejecting heads.

What is claimed is:

1. A liquid ejecting head comprising:
multiple pressure chambers that communicate with corresponding nozzle openings that eject a liquid;
a pressure generation unit that generates the pressure in the pressure chambers;
a manifold that is a common liquid chamber communicating with the multiple pressure chambers;
supply paths that fluidly communicate with the multiple pressure chambers to the manifold; and
supply openings, formed on the manifold side of corresponding supply paths, having openings that have a shape in which an inscribing circle is present.

2. The liquid ejecting head according to claim 1,
wherein the shape of the openings is an oval shape.

3. The liquid ejecting head according to claim 1,
wherein each of the openings includes:
a first opening that opens into the manifold and that has a shape in which a first inscribing circle is present; and
a second opening, provided more toward the pressure chambers than the first opening, that has a shape in which a second inscribing circle that is smaller than the first inscribing circle is present.

4. The liquid ejecting head according to claim 3,
wherein the shape of the first openings and the second openings is an oval shape; and
the length of the long axis of the second opening is longer than the length of the short axis of the first opening.

5. A liquid ejecting apparatus comprising:
the liquid ejecting head according to claim 1.
